(19) United States
(12) Patent Application Publication
(10) Pub. No.: US 2010/0135726 A1
(43) Pub. Date: Jun. 3, 2010

(54) Apparatus and method for generating waves

(76) Inventor: André Clauss, Hamburg (DE)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 12/519,810

(22) PCT Filed: Dec. 17, 2007
(86) PCT No.: PCT/EP2007/011051

§ 371 Date: Feb. 9, 2010

(30) Foreign Application Priority Data
Dec. 18, 2006 (DE) 10 2006 059 971.3

(51) Int. Cl. A01K 63/00

(52) U.S. Cl. 405/79

(57) ABSTRACT

An apparatus for generating waves in a liquid container, with a container, which has an outlet opening in the upper region and an inlet opening in the lower region, and a shiftable body, which is arranged in said container and which can move in the direction towards the outlet opening in the container as a result of a buoyancy- or spring force, so that the liquid situated before the body in the movement direction is pressed through the outlet opening.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The present invention is related to an apparatus and a method for generating waves in a liquid container.

The generation of flow- and wave movements is important for different applications. In the present invention, it is mainly dealt with the field of aquaristics, of seawater aquaristics in particular, where a permanent recirculation of the water is necessary within an aquarium, in order to ensure a sufficient transportation of oxygen and foodstuff, and to maintain species-appropriate living conditions for the sea animals kept in the aquarium. Comparable demands exist also in aquacultures, for instance for fish farming and larvae breeding, so that an application of the apparatus and the method for generating waves can make sense even in this field.

Pumps are normally used for the recirculation of the water in aquaria, which convey a continuous flow of water. The flow of water can be introduced directly into the aquarium. It is also known to use obstacles in the region of the water outlet, which lead to turbulences and broaden the water jet that would possibly be too hard otherwise, making it softer through this.

Starting from this, it is the objective of the present invention to provide an apparatus and a method for generating waves in a liquid container, which permits a recirculation of the water that better simulates the natural conditions.

The present invention is based on the finding that the utilisation of pumps with continuous water conveyance can provoke a continuous recirculation of the water in fact, but is not suited for the generation of waves, i.e. of periodical water movements, which propagate themselves in a pulsating way. However, just such wave movements are characteristic for the natural movements of the sea water. Moreover, it has been recognised that pumps with normally rapidly rotating parts can damage small creatures living in the water, plankton in particular, and that their operation is often accompanied by a development of noise hardly tolerable in living rooms.

### BRIEF SUMMARY OF THE INVENTION

The apparatus of the present invention serves for generating waves in a liquid container and has a container, which has an outlet opening in the upper region and an inlet opening in the lower region, and a shiftable body, which is arranged in the container and which can move in the direction towards the outlet opening in the container as a result of a buoyancy- or spring force, so that the liquid situated before the body in the movement direction is pressed through the outlet opening

The apparatus can be also designated as a wave generator. The wave generator, made up of container and body, is situated in the liquid container when it is in operation, in a sea water aquarium for instance. The entire wave generator can be situated below the water line in this; however, at least the inlet and outlet openings are necessarily situated below the water line.

The container has an interior space with a cross section that is uniform within the movement region of the body. The cross section may have any arbitrary form. Preferably, the cross section is annular, and the entire container is a circular cylinder. The inlet opening is preferably arranged in a lateral wall of the container, so that when the apparatus is set into the liquid container, it is not covered by the bottom thereof. It may have a distance from the lower end of the container, so that it remains freely accessible even then when the apparatus sinks partly down into the “sea bed”. The inlet opening can be one single opening of rectangular cross section, for instance, or it may be formed by several neighbouring openings in the lower region of the container. The outlet opening is also preferably formed in a lateral wall of the container. Its arrangement determines the break-through direction of the waves. Thus, a lateral arrangement leads to a wave propagation circa parallel to the water surface, which approximates the desired, as natural as possible wave movement particularly well. The outlet opening is dimensioned as big that an uninterrupted water exit with a flow velocity occurring at natural wave movements is made possible. A punctiform water exit with high flow velocity, which might have a deleterious effect, is avoided by the big cross section. Preferably, outlet opening and inlet opening are arranged on the same side of the container, in order to allow a circulating movement of the water.

The body is shiftably arranged within the container and preferably over a big part of the overall length of the same in it. The cross section of the body is matched to the interior space of the container, such that it approximately occupies the cross section of the interior space, but remains easily movable without blocking at the same time. In order to avoid blocking, a gap may remain between the body and the inner wall of the container, which will not easily be clogged by suspended matter or other particles in the water. The body can move in the container like a piston. When it moves in the direction towards the outlet opening, it displaces the liquid situated before the body in the movement direction and presses it out through the outlet opening, by which a wave is generated in the liquid container. The upward movement of the body in the direction towards the outlet opening is mediated by a buoyancy force or by the force of a spring. The buoyancy force is preferably generated by the buoyancy of the body itself, due to a smaller density of the container with respect to the surrounding liquid, for instance by a hollow space filled with air within the body. The hollow body can by closed on all sides in this, or it may be open at the downside. By introducing a certain amount of air into the hollow body, the buoyancy force can be adjusted, and by doing so the velocity of the upward movement and the strength of the generated wave. In this way, the apparatus can be adapted to the individual requirements of different aquaria in a simple way. Also conceivable is the use of buoyancy bodies, of a dense foam material for instance, which are arranged in a hollow space of the body or below the body. Alternatively, the upward movement can be caused by a spring, which can be arranged between the body and the lower end of the container, for instance.

A drive is provided in one embodiment, which can bring the body from an end position in the upper region of the container into a starting position in the lower region of the container. The drive may be an electric drive in particular. By this, the body can be brought into its starting position for the upward movement that is caused by buoyancy- or spring force automatically, in order to generate a further wave. Thus, waves can be continuously generated in a cyclic process. A further advantage is that the upward movement depends solely on the buoyancy- or spring force acting on the body, whereas the upward movement is solely determined by the drive. As a consequence, both movements can be tuned to the respective requirements independently from each other.

In one embodiment, the drive has a threaded spindle and a mechanism for hooking in/out is arranged on the body, said mechanism for hooking in/out co-operating with the threaded spindle. The threaded spindle may be also designated as a screw shaft.

In this embodiment, a guiding can be provided on the body, which prevents any distortion of the body with respect to the container, in order to avoid that the body rotates along with the threaded spindle. The control of the upward or downward movement of the body, respectively, can take place solely by the mechanism for hooking in/out, wherein the thread of the threaded spindle takes the body along in the hooked-in state of the mechanism for hooking in/out, and releases it in the hooked-out state. For this purpose, the mechanism for hooking in/out can be realised such that it hooks in automatically, when the body reaches its end position in the upper region of the container after the upward movement, and that it hooks out automatically when the body reaches its starting position after the downward movement. In this case, any control of the drive can be omitted, and the threaded spindle can be kept in continuous rotary movement by the drive.

In one embodiment, the mechanism for hooking in/out has a pusher, which engages into the thread of the threaded spindle in a first pusher position, and is spaced apart from the thread of the threaded spindle in a second pusher position. Thus, a simple and robust construction of the mechanism for hooking in/out can be realised.

In one embodiment, a control element is arranged in the upper region of the container, which shifts the pusher into the first pusher position when the body reaches its end position in the upper region of the container. For instance, the control element may be a wedge or another guiding surface, which acts on the pusher during the downward movement. In this, the control element is arranged such that it shifts the pusher at the end of the upward movement, the downward movement beginning automatically with the aid of the spindle drive through the engagement of the pusher into the thread, which is established thereby.

In one embodiment, a spring is provided, which exerts a force on the pusher in the direction towards the second pusher position. With respect to its strength and action direction, the spring can be arranged such that the pusher remains in the first pusher position as long as it is in engagement with the thread of the threaded spindle. During this time, the thread exerts a force on the pusher which is directed essentially towards the downside on that portion of the pusher that is in engagement with the thread. When the body has reached its starting position in the lower region of the container, the thread of the threaded spindle may end, through which the force exerted on the pusher by the thread suddenly drops to zero. In this moment, the force of the spring causes the desired dislocation of the pusher into its second position, so that the upward movement of the body is triggered automatically.

In one embodiment, the drive has a magnetic coupling arranged outside of the container. The magnetic coupling acts on the body by way of a magnetic force, and can be moved in the movement direction of the body by the drive outside of the container. Through this, a movement of the body is possible without that driving elements are arranged within the body.

In one embodiment, the outlet opening is arranged in a lateral container wall and spaced apart from an upper wall of the container, a chamber being formed in the container above the outlet opening thereby. This embodiment has the result that the upward movement of the body is not ended suddenly by a bounce of the body on the upper container wall, but is slowly braked down beforehand and smoothly stopped by the water remaining in the chamber. Through this, the free cross section of the outlet opening is reduced by the ascending body at first, which increasingly covers the outlet opening. Because of the flow resistances that increase by this, the speed of the body is slowed down already in this phase. When the body has reached the upper end of the outlet opening, apart from leaking no more water can escape from the chamber situated above the piston, and the upward movement is ended.

In one embodiment, the outlet opening has a recess in its upper edge, the width of said recess decreasing in the movement direction of the body. Through this, the brake-down process of the upward movement depicted above becomes even freer of jerks, because the liquid remaining in the chamber can escape slowly, as long as the body has not yet closed the recess. In this, the cross section of the remaining outlet opening decreases continuously with the upward movement of the body, so that it finally ends. The smooth ending of the movement achievable in this way acts advantageously on the noise development of the apparatus and helps to avoid shocks.

In one embodiment, a pipe with a valve is situated in the body, which is closed in an upward movement of the body and opened in a downward movement of the body. The pipe may extend over the entire height of the body, or it may be essentially reduced to a circular opening in the body. The valve inserted therein opens during the downward movement of the body in order to allow a flow of the liquid from the lower region into the upper region of the container. Without this compensation possibility, a back flow of liquid into the container through the outlet opening would occur. This back flow movement could disadvantageously affect the desired natural wave movement. Besides, the flow resistance of the body is reduced, so that the drive can be dimensioned smaller according to the circumstances.

In one embodiment, the inlet opening is provided with a valve, which is opened in an upward movement of the body and closed in a downward movement of the body. Through this, a back flow movement through the inlet opening during the downward movement of the body is prevented. For instance, the valve can be formed by a flap which covers the inlet opening from the inside.

In one embodiment, a connection between the upper and the lower region of the container is provided, which is formed by a line outside of the container, or by a chamber in the interior of the container. Through this, a compensation possibility between the upper and the lower container portion during the downward movement of the body is created as an alternative to the valve in the body. The chamber inside the container can be separated from the remaining container volume by a partition wall arranged in the container, wherein the partition wall and the outer wall of the container are preferably arranged parallel in the region of the chamber, so that a double container wall forms the chamber.

In one embodiment, a valve is arranged in the connection between the upper and the lower region of the container, said valve being closed in an upward movement of the body and being opened in a downward movement of the body. This valve prevents an undesired flow through the connection during the upward movement of the body.

In one embodiment, a valve element is provided, which closes the inlet opening in the lower region of the container and opens the connection between the upper and the lower region of the container in a first valve element position, and opens the inlet opening in the lower region of the container and closes the connection between the upper and the lower region of the container in a second valve element position. In this way, the inlet opening as well as the connection between upper and lower region is controlled by one single adjustable valve element. For instance, the valve element can be annular and arranged to be movable in the movement direction of the body, i.e., in the longitudinal direction of the container. In a lower position, this valve ring can cover the inlet opening from the inside, however, in an upper position the opening for connection between upper and lower region of the container can be covered. A particularly simple solution for the realisation of the two valves is found thereby.

In one embodiment, a mechanism for hooking in/out is arranged on the valve element, which co-operates with the threaded spindle. The mechanism for hooking in/out can be realised similar to the already explained mechanism for hooking in/out on the body. In this embodiment, the valve element can be brought into its lower position by the body that moves downward, wherein the mechanism for hooking in/out on the valve element hooks in at the end of the downward movement. Subsequently, the valve element can be transported into the upper position by a thread portion of the threaded spindle, where the mechanism for hooking in/out hooks out. The rotational sense of the thread in this thread portion can be directed opposite to that of the thread in the portion co-operating with the mechanism for hooking in/out on the body. Due to the flow in the container, the valve element can automatically remain in the upper position for so long as the body moves upward.

The method of the present invention according to claim 16 serves for the generation of waves in a liquid container and has a container, which has an outlet opening in the upper region and an inlet opening in the lower region, and a slidable body, which is arranged in the container, wherein the body moves in the container in the direction towards the outlet opening as a result of a buoyancy- or spring force and presses the liquid situated before the body in the movement direction through the outlet opening.

In one embodiment, the body is moved in a cyclic way, wherein in a first process step, it is brought into its end position, starting from the starting position and as a result of the buoyancy- or spring force, and in a second process step it is brought back from the end position into the starting position by the drive.

In one embodiment, such a movement cycle of the body occupies a period of time of 2 s to 20 s. At normal conditions, a period of time of 4 s to 8 s will be particularly suited. With this cycle duration, a particularly nature-like wave motion is achieved in aquaria of usual size.

To further embodiments of the method indicated in the subclaims has already been incurred in the context of the apparatus.

### BRIEF DESCRIPTION OF THE SEVERAL VIEWS OF THE DRAWINGS

Below, the present invention is explained in more detail by way of examples of its realisation depicted in Figures.

FIG. 1: a first realisation example of the invention, with buoyancy body and valve ring;

FIG. 2: a second realisation example of the invention, with buoyancy body, a line between the upper and the lower container region and a valve on the inlet opening;

FIG. 3: a third realisation example of the invention, with buoyancy body and a valve arranged in a pipe in the body;

FIG. 4: a fourth realisation example of the invention, with a body moved upward by a spring;

FIG. 5: a fifth realisation example of the invention, with a body moved upward by a spring and a magnetic coupling;

FIG. 6: a mechanism for hooking in/out of a further realisation example in a cross section;

FIG. 7: the cross section of an outlet opening of a further realisation example in a top view.

### DETAILED DESCRIPTION OF THE INVENTION

While this invention may be embodies in many different forms, there are described in detail herein a specific preferred embodiment of the invention. This description is an exemplification of the principles of the invention and is not intended to limit the invention to the particular embodiment illustrated.

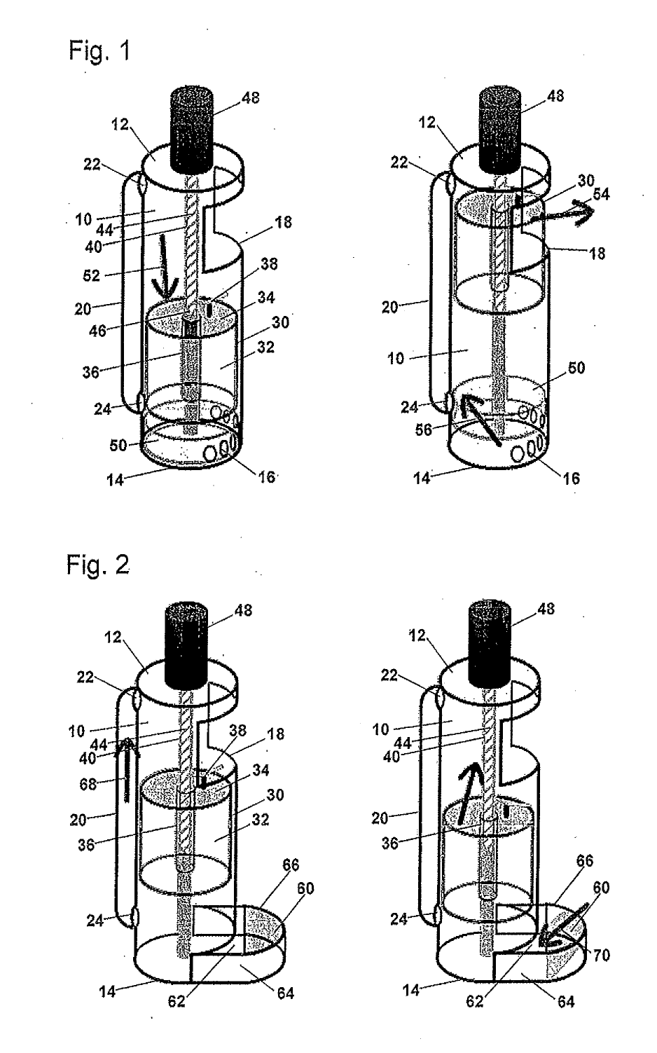

All the figures show schematic, strongly simplified representations, perspective views being chosen in the FIGS. 1 to 5. In each of the FIGS. 1 to 6, a condition of the apparatus during the downward movement of the body is shown on the left side, and a condition of the apparatus during the upward movement of the body is shown on the right side, Same reference signs are used for corresponding parts for all the realisation examples.

In the realisation example shown in FIG. 1, the container consists of a cylindrical pipe 10 with a circular cross section, which is closed on the upper and the lower end by an upper wall 12 and a lower wall 14 respectively. In its lower region, the pipe 10 has several circular inlet openings 16 shortly above the lower wall, which are arranged at equal height one besides to the other. They are situated on that side of the pipe 10 pointing to the right in the picture. In the upper region of the pipe 10, a rectangular outlet opening 18 is arranged on the same side as the inlet openings 16. Two sides of the rectangle run in the horizontal, two in the vertical direction. The upper side of the rectangle, i.e. the upper edge of the inlet opening 18, is in a distance from the upper wall 12 of the container. The cross section of the outlet opening 18 is substantially greater than the cross section of the plurality of inlet openings 16. The outlet opening 18 has a width which corresponds about to one third of the pipe perimeter; the height of the outlet opening 18 is about one fifth of the length of the pipe 10. On the side of the pipe opposite to the inlet openings 16 and the outlet opening 18, depicted on the left side in the figure, a pipeline 20 is arranged at the outside, which runs in the vertical direction along the container wall and connects a circular through bore 22 near to the upper wall 12 with a circular through bore 24 in the lower region of the container, but above the inlet openings 16.

In the interior of the container, there is a body 30 in the form of a circular cylinder. The body 30 has a cylindrical circumferential surface 32, which is arranged near to the inner wall of the pipe 10, and it can move up and down in the pipe 10 like a piston in a cylinder. The upper circular surface of the body 30 is closed by a surface 34. The body 30 has a round passage opening 36 along its symmetry axis. In the upper region of the body 30, a mechanism for hooking in/out 38 only foreshadowed in the figure is fixed on the surface 34. The body 30 is prevented from twisting with respect to the container by a suitable guiding, which is not shown in the figure.

A threaded spindle 40 runs through the passage opening 36 in the body 30, which is bearing mounted in the middle of the lower wall 14 and guided through the centre of the upper wall 12. It runs along the symmetry axis of the pipe 10. The upper portion of the threaded spindle 40 is provided with a thread 44, which runs out above the lower wall 14, as foreshadowed at 46. Above the upper wall 12 there is an electric drive 48, which drives the threaded spindle 40 and excites the same to a uniform rotational movement.

In the lower region of the container, there is a horizontally arranged valve ring 50 in the interior of the pipe, which covers the inlet opening 16 from the inside in the position represented at the left side in the figure, and closes it by this. Like the body 30, the valve ring 50 sits relatively close to the inner side of the pipe 10, but without blocking.

In the operation, the apparatus is situated in a liquid container below the water line at least up to the upper edge of the outlet opening 18, in a sea water aquarium in particular.

The arrow 52 indicates the downward movement of the body 30 depicted in the left part of FIG. 1. In the downward movement, the mechanism for hooking in/out 38 is in a hooked-in condition, so that it co-operates with the thread 44, and the body 30 is moved downward by the drive 48. Because the valve ring 50 closes the inlet openings 16 in this case, the water flows from the lower region of the container through the pipeline 20 into the upper region thereof in the downward movement of the body.

In the right portion of FIG. 1, the condition of the apparatus during the upward movement of the body 30 is shown. In this, the water exits through the outlet opening 18, as indicated by the arrow 54, and it enters into the container through the inlet openings 16, as indicated by the arrow 56. The valve ring 50 is in an upper position, so that the inlet openings 16 are opened and the passage opening 24 to the pipeline 20 is closed. Through this, a back flow from the upper region into the lower region of the container through the pipeline 20 is prevented, and all the water that is pressed towards the upside by the body 30 is guided through the outlet opening 18 into the liquid container, where a wave is generated. In the shown realisation example, the body 30 moves upward only due to its buoyancy. The mechanism for hooking in/out 38 is hooked out at the end of the thread 44 in the end of the downward movement of the body 30, so that the body 30 can freely ascend towards the upside. When the body 30 has arrived in the upper region of the container, the upper end of the body 30 being approximately on the height of the upper end 18 of the outlet opening and thus in a distance from the upper wall 12 of the container, the mechanism for hooking in/out 38 hooks in again and the body 30 is moved towards the downside anew.

In the second realisation example of FIG. 2, a valve flap 60 is provided instead of the valve ring, which is arranged in an upper wall 62 of a horizontally running extension 64, which laterally follows up the lower end of the pipe 10. During the downward movement of the body 30 shown at left, the flap is closed, so that it closes up an inlet opening 66 in the extension 64. At the same time, the water flows from the lower region of the container into the upper region through the pipeline 20, as illustrated by the arrow 68.

During the upward movement of the body shown at the right side in FIG. 2, the flap 60 is opened and uncovers the inlet opening 66, so that the water can flow into the container through the inlet opening 66, as indicated by the arrow 70. A further, not depicted valve may be arranged in the pipeline 20, which prevents any back flow of the water from the upper region of the container into the lower region of the container through the pipeline 20.

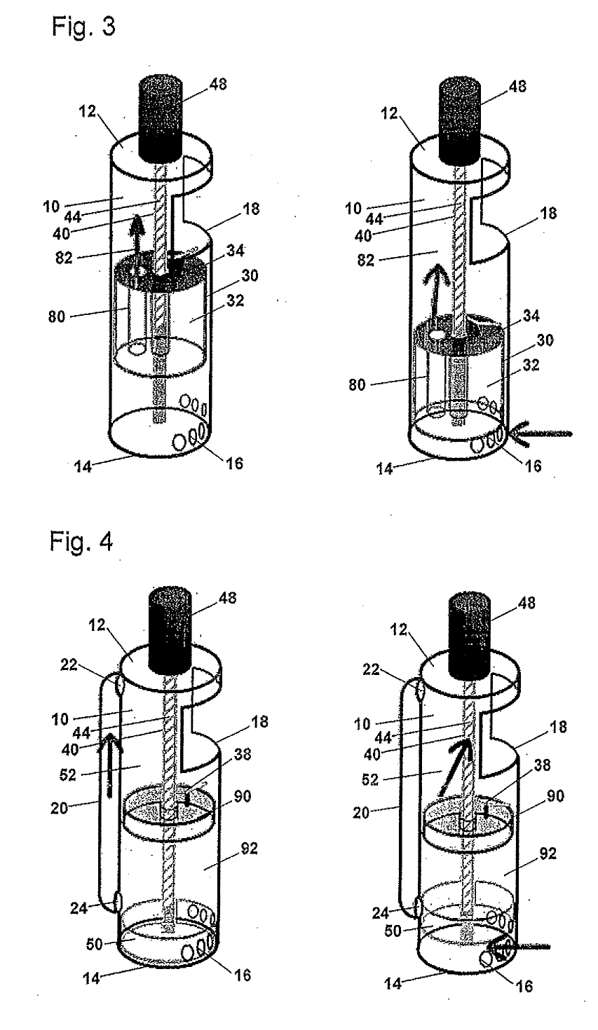

In the third realisation example of FIG. 3, there is no pipeline arranged at the outside of the container. Instead, a second, tubular passage opening 80 having a not depicted valve therein is arranged in the body 30. With respect to the upward movement due to a buoyancy force and the downward movement by the drive 48 with threaded spindle 40, there are no differences to the two preceding realisation examples. The valve in the body 30 is opened during the downward movement, and the water can flow through the passage opening 80 from the lower into the upper region of the container, as indicated by the arrow 82. A further valve can be arranged on the inlet openings 16, which closes the same during the downward movement of the body 30. In the upward movement shown at the right side, the valve in the passage opening 80 is closed, so that the water escapes from the upper region of the container only through the outlet opening, and flows into the lower region of the container through the inlet openings 16.

In the realisation example of FIG. 4, the body 90 is moved upward not by a buoyancy force, but predominantly by the force of a spring 92. The body 90 is disc-shaped and has a smaller height than the body 30 of the preceding realisation examples. The spring 92 is arranged between the body 90 and the lower wall 14 of the container. The other details correspond to those of the first realisation example with a valve ring 50, and are given reference signs accordingly. As for the function, it is made reference to the first realisation example. A difference to the first realisation example is that the force of the spring 92 instead of the buoyancy force of the body must be overcome in the downward movement of the body 90 caused by the drive 48.

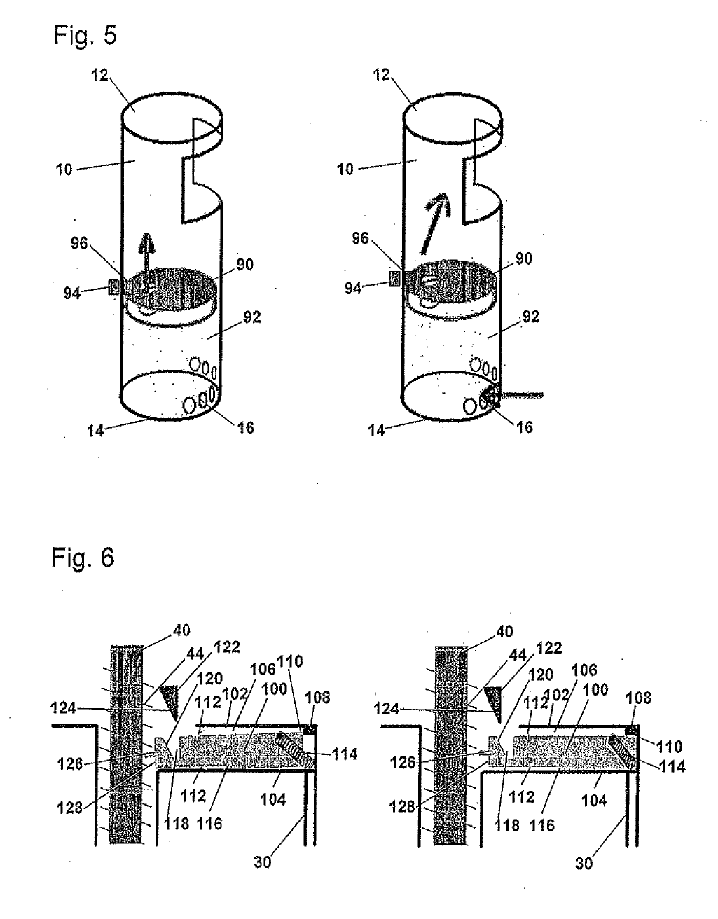

The realisation example of FIG. 5 has also a disc-shaped body 90, movable upward by a spring 92, and insofar it is similar to the realisation example of FIG. 4. However, instead of the drive with a threaded spindle, a magnetic coupling arranged on the container at the outside thereof is used, which has a magnet 94 which co-operates with a second magnet 96 fixed on the body 90, or with a ferromagnetic part on the body 90. The upward movement of the body 90 is mediated by the spring 92 again, whereas the downward movement is caused by a not shown drive, which moves the magnet 94 downward, the body 90 following the movement because of the magnetic forces.

FIG. 6 shows details of a mechanism for hooking in/out, which has a pusher 100, movable horizontally towards the threaded spindle 40 and away from the same, which is arranged on the body 30 in a hollow space 106 formed by an upper periphery 102 and a lower periphery 104. The pusher 100 has essentially the form of an oblong cuboid, and is guided by further, not shown lateral peripheries in the hollow space 106. The hollow space 106 has a limit stop 108 at the end remote from the threaded spindle 40, which co-operates with the upper edge 110 of the pusher 100 remote from the threaded spindle 40. By two foil elements 112 running from the pusher 100 to the peripheries 102 and 104, the part of the pusher 100 arranged in the hollow space 106 and the hollow space 106 itself is separated from the surrounding water in order to preclude contamination. A force is applied by a spring 114 to that end of the pusher 100 which is remote from the threaded spindle, said force acting towards the rear side and towards the downside. The spring 114 can be embedded in a not shown recess of the pusher 100. The pusher 100 is guided in the hollow space 106 with some clearance, so that it can not only move back and forth, but can also be tilted over an edge 116 projecting approximately in the centre of the lower surface of the pusher, transversely to the longitudinal direction thereof.

On the end facing the threaded spindle 40, the pusher has a groove 118 in its upper surface, which has a skew side face 120. In the upper region of the container not shown in the figure is arranged a wedge-shaped control element 122, which comes into contact with the side face 120 with a skew side face 124 thereof, when the body 30 approaches its end position. Then, the control element 122 thrusts the pusher 100 into the first pusher position shown in the left part of the figure, in which a projection 126 in the surface 128 of the pusher 100 facing the threaded spindle 40 engages into the thread 44 of the threaded spindle 40, and the pusher 100 is tilted over the edge 116, so that the edge 110 of the pusher abuts against the limit stop 108. During the downward movement of the body 30, there is furthermore a downward directed force onto the front end of the pusher 100, which the thread 44 exerts on the projection 126 of the pusher 100. Through this, the pusher remains in the tilted position and can not slip back into the hollow space 106 by passing along the limit stop 108. Therefore, the pusher 100 remains in the first pusher position for so long as the thread 44 is in engagement with the projection 126. Through this, the body 30 is moved downward by the drive as desired, until the thread 44 ends and does no more exert any force on the projection 126. In this moment, the pusher 100 slips back into its second pusher position shown in the right-side part of the figure, by the force of the spring 114 and passing along the projection 108. Thus, the projection 126 is at a distance from the threaded spindle 40, so that the body 30 can begin its upward movement unhinderedly.

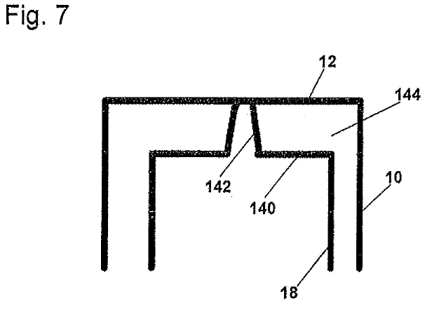

FIG. 7 shows a top view from the side on the upper part of an outlet opening 18 in a container. The upper part of the cylindrical pipe 10 and the upper wall 12 of the container is visible. The outlet opening 18 is rectangular and has a recess 142 on its upper edge 140, which tapers towards the upside in a wedge shape and leads up to the upper wall 12, A small and steadily diminishing flow of liquid can exit from the chamber 144 above the outlet opening 18 through the recess 142 in the upward movement of the body 30, in order to brake down the upward movement of the body 30 slowly.

Below, some aspects of the present invention are expressed in other words again.

In sea water aquaria in particular, generation of waves which show a natural behaviour is not possible up to now, because the known methods are either accompanied by development of noise which is not admissible in a living room, or cause only a rocking of the water which does not enable a sufficient transportation of matter, Moreover, rapidly rotating or movable parts destroy plankton living in the water. This applies for conventional rotary pumps, for instance.

The present invention resolves these problems by a solid container, which is provided with an outlet opening in the upper region and with an inlet opening in the lower region, and in which a body driven by its buoyancy force and/or by means of a relaxing elastic spring moves in the direction of the outlet opening, so that the liquid situated before the body is pressed out of the outlet opening. Due to a discontinuous behaviour, a wave will propagate impulse-like outside the container.

In order to be able to brake down the shiftable body at the end of its course in an almost noiseless way, the outlet opening does not end flush with the end of the container, but provides a reservoir or a closed chamber for the liquid, respectively.

The liquid-displacing body is brought into the starting position in the lower container region by means of a worm gear shaft or a magnetic coupling situated at the outside.

By making use of the buoyancy and/or the force of a relaxing elastic spring, an external energy supply is required only for this single process. When the (buoyancy-) body is brought into the starting position in the lower container region, the liquid situated below the body would be pressed out of the inlet opening. In order to remedy this if need be, there are two possibilities, which can be optionally supplemented according to utilisation demand:
a) A correspondingly dimensioned pipe with valve is in the (buoyancy) body, which is closed by the generated counter pressure only in the buoyant lift, but otherwise provides a passage of liquid or a pressure compensation, respectively.
b) The inlet opening is provided with a valve, which is opened in the buoyant lift process, and closed by the counter pressure of the liquid that wants to exit in the transfer into the starting position.

Yet, in order to allow a back transfer or a pressure compensation, respectively, either an external pipeline connecting the beginning of the container and the end of the container, or a second container chamber is used.

Aquaria serving for keeping maritime creatures are intended as the main applications of the present invention. By the construction, protection of the plankton is provided for the first time, and at the same time a nature-like water recirculation/movement. Quite new possibilities result thereby, among others for breeding plankton and for keeping bio-filtrators and the like.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. An apparatus for generating waves in a liquid container, with
a container, which has an outlet opening (18) in the upper region and an inlet opening (16) in the lower region, and
a shiftable body (30, 90), which is arranged in said container and which can move in the direction towards the outlet opening (18) in the container as a result of a buoyancy- or spring force, so that the liquid situated before the body (30, 90) in the movement direction is pressed through the outlet opening (18).

2. An apparatus according to claim 1, characterised in that a drive (48) is provided, which can bring the body (30, 90) from an end position in the upper region of the container into a starting position in the lower region of the container.

3. An apparatus according to claim 2, characterised in that the drive (48) has a threaded spindle (40) and that a mechanism for hooking in/out (38) is arranged on the body (30), said mechanism for hooking in/out co-operating with the threaded spindle (40).

4. An apparatus according to claim 3, characterised in that the mechanism for hooking in/out (38) has a pusher (100), which engages into the thread (44) of the threaded spindle (40) in a first pusher position, and is spaced apart from the thread (44) of the threaded spindle (40) in a second pusher position.

5. An apparatus according to claim 4, characterised in that a control element (122) is arranged in the upper region of the container, which shifts the pusher (100) into the first pusher position when the body (30, 90) reaches its end position in the upper region of the container.

6. An apparatus according to claim 4, characterised in that a spring (114) is provided, which exerts a force on the pusher (100) in the direction towards the second pusher position.

7. An apparatus according to claim 2, characterised in that the drive (48) has a magnetic coupling (94) arranged outside of the container.

8. An apparatus according to claim 1, characterised in that the outlet opening (18) is arranged in a lateral container wall (10) and spaced apart from an upper wall (12) of the container, wherein a chamber (144) is formed in the container above the outlet opening (18).

9. An apparatus according to claim 8, characterised in that the outlet opening (18) has a recess (142) in its upper edge (140), the width of said recess decreasing in the movement direction of the body (30, 90).

10. An apparatus according to claim 1, characterised in that a pipe (80) with a valve is situated in the body (30, 90), which is closed in an upward movement of the body (30, 90) and opened in a downward movement of the body (30, 90).

11. An apparatus according to claim 1, characterised in that the inlet opening (16) is provided with a valve (50, 60), which is opened in an upward movement of the body (30, 90) and closed in a downward movement of the body (30, 90).

12. An apparatus according to claim 11, characterised in that a connection between the upper and the lower region of the container is provided, which is formed by a line (20) outside of the container, or by a chamber in the interior of the container.

13. An apparatus according to claim 12, characterised in that a valve is arranged in the connection between the upper and the lower region of the container, said valve being closed in an upward movement of the body (30, 90) and being opened in a downward movement of the body (30, 90).

14. An apparatus according to claim 13, characterised in that a valve element (50) is provided, which closes the inlet opening (16) in the lower region of the container and opens the connection (20) between the upper and the lower region of the container in a first valve element position, and opens the inlet opening (16) in the lower region of the container and closes the connection (20) between the upper and the lower region of the container in a second valve element position.

15. An apparatus according to claim 14, characterised in that a mechanism for hooking in/out is arranged on the valve element (50), which co-operates with the threaded spindle. (40).

16. A method for generating waves in a liquid container, with
a container, which has an outlet opening in the upper region (18) and an inlet opening (16) in the lower region, and
a slidable body (30, 90), which is arranged in the container, wherein the body (30, 90) moves in the container in the direction towards the outlet opening (18) as a result of a buoyancy- or spring force and presses the liquid situated before the body (30, 90) in the movement direction through the outlet opening (18).

17. A method according to claim 16, characterised in that a drive (48) is provided, which brings the body (30, 90) from an end position in the upper region of the container into a starting position in the lower region of the container.

18. A method according to claim 17, characterised in that the body (30, 90) is moved in a cyclic way, wherein in a first process step, it is brought into its end position, starting from the starting position and as a result of the buoyancy- or spring force, and in a second process step it is brought back from the end position into the starting position by the drive (48).

19. A method according to claim 18, characterised in that one movement cycle of the body (30, 90) occupies a period of time of 2 s to 20 s.

20. A method according to claim 18, characterised in that the drive (48) has a threaded spindle (40) and that a mechanism for hooking in/out (38) is arranged on the body (30), said mechanism for hooking in/out co-operating with the threaded spindle (40), wherein the mechanism for hooking in/out (38) hooks in at the end of the first process step, and hooks out at the end of the second process step.

21. A method according to claim 20, characterised in that the mechanism for hooking in/out (38) has a pusher (100), which engages into the thread (44) of the threaded spindle (40) in a first pusher position, and is spaced apart from the thread (44) of the threaded spindle (40) in a second pusher position, and that a control element (122) is arranged in the upper region of the container, wherein the pusher (100) is shifted into the first pusher position by the control element (122) at the end of the first process step.

22. A method according to claim 20, characterised in that a spring (114) is provided, which exerts a force on the pusher (100) in the direction towards the second pusher position, wherein the spring (114) shifts the pusher (100) into the second pusher position at the end of the second process step.

23. A method according to claim 17, characterised in that the drive (48) has a magnetic coupling (94) arranged outside of the container.

24. A method according to claim 18, characterised in that a pipe (80) with a valve is situated in the body (30, 90), which is closed in the first process step and opened in the second process step.

25. A method according to claim 16, characterised in that the outlet opening (18) is arranged in a lateral container wall (10) and spaced apart from an upper wall (12) of the container, wherein a chamber (144) is formed in the container above the outlet opening (18), and the body (30, 90) does not come into contact with the upper wall (12) of the container at the end of the first process step.

26. A method according to claim 25, characterised in that the outlet opening (18) has a recess (142) in its upper edge (140), the width of said recess decreasing in the movement direction of the body (30, 90), and that the upward movement slowly decreases at the end of the first process step.

27. A method according to claim 16, characterised in that the body (30, 90) and/or the container is provided with a valve.
